(19) United States
(12) Patent Application Publication
(10) Pub. No.: US 2005/0197987 A1
(43) Pub. Date: Sep. 8, 2005

(54) Systems and methods for selecting a value set

(76) Inventors: David M. Anderson, Fort Collins, CO (US); Tyson R. McGuffin, Fort Collins, CO (US); Thomas W. Chen, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/761,479

(22) Filed: Jan. 21, 2004

(51) Int. Cl. G06N 5/00

(52) U.S. Cl. 706/45

(57) ABSTRACT

Systems and methods are provided for selecting a value set associated with a set of parameters. A real cost function generates a real cost for a first value set associated with a set of parameters. A genetic algorithm generates a second value set that is a variation of the first value set. A cost function approximator determines an approximate cost based on the real cost and a value set variation between the second value set and the first value set.

### CROSS REFERENCE TO RELATED APPLICATIONS

This application is related to the following commonly assigned co-pending patent applications entitled: “SPECULATION COUNT IN A GENETIC ALGORITHM,” Attorney Docket No. 200309413-1; “SPECULATIVE POOL,” Attorney Docket No. 200309414-1; “POSTPONING VALIDATION OF SPECULATIVE CHROMOSOMES,” Attorney Docket No. 200309415-1, all of which are filed contemporaneously herewith and are incorporated herein by reference.

### BACKGROUND

Genetic algorithms are application technologies inspired by mechanisms of inheritance and evolution of living things. In the evolution of living things, genomic changes like crossovers of chromosomes and mutations of genes can occur when new individuals (children) are born from old individuals (parents). In a genetic algorithm, a candidate of a solution to a problem is represented as a data structure, referred to as a chromosome. The data structure represents a plurality of variables or bits referred to as genes. A plurality of n-bit parent chromosomes can be generated and assigned a fitness based on an evaluation of a fitness function. In certain applications, fitness corresponds to a cost associated with a chromosome with a lower cost being more fit than chromosomes with higher costs. Chromosomes with lower costs can be selected for generating new children chromosomes. Children chromosomes are generated through a process of crossover and mutation of parent chromosomes to produce new child chromosomes. Child chromosomes with lower costs or better fitness replace members of the population with higher costs or less fit chromosomes to assure evolutionary advance to an optimal solution.

### SUMMARY

Systems and methods for selecting a value set associated with a set of parameters are disclosed. One embodiment of the present invention relates to a value set selection system. The value set selection system comprises a real cost function that generates a real cost for a first value set associated with a set of parameters. A genetic algorithm generates a second value set that is a value set variation of the first value set. A cost function approximator determines an approximate cost based on the real cost and the value set variation between the first and second value set.

In another embodiment, a system is disclosed for selecting a value set associated with a set of parameters. The system includes a real cost function that determines a real cost for each of a plurality of real chromosomes. Each real chromosome represents a different value set associated with a set of parameters. A genetic algorithm generates a first generation of speculative children chromosomes from parents selected from the plurality of real chromosomes. The genetic algorithm also generates subsequent generations of speculative children chromosomes from parents selected from at least one of preceding generations of speculative chromosomes and real chromosomes. The speculative chromosomes represent incremental differences in the value sets between at least one parent chromosome and an associated child chromosome. An incremental cost function determines speculative costs for a given speculative chromosome based on the incremental difference in the value sets between at least one parent chromosome and an associated child chromosome, and the cost associated with at least one of the parent chromosomes.

Another embodiment relates to a method for selecting a value set associated with a set of parameters. The method comprises determining a real cost of a first value set associated with a set of parameters, and generating a second value set based on a difference in at least one value of the first value set. A speculative cost is approximated for the second value set based on the difference and the real cost.

### BRIEF DESCRIPTION OF THE DRAWINGS

FIG. 1 illustrates a block diagram of an embodiment of a system for selecting a value set associated with a set of parameters.

FIG. 2 illustrates a block diagram of an alternate embodiment of a system for selecting a value set associated with a set of parameters.

FIG. 3 is an embodiment of a graph that illustrates a relationship between an exemplary cost function and a plurality of incremental cost functions.

FIG. 4 illustrates a block diagram of an embodiment of a system for selecting a circuit design configuration.

FIG. 5 is a flow diagram that illustrates an embodiment of a methodology for selecting a value set associated with a set of parameters.

FIG. 6 is a flow diagram that illustrates another embodiment of a methodology for selecting a value set associated with a set of parameters.

FIG. 7 illustrates an embodiment of a computer system.

### DETAILED DESCRIPTION

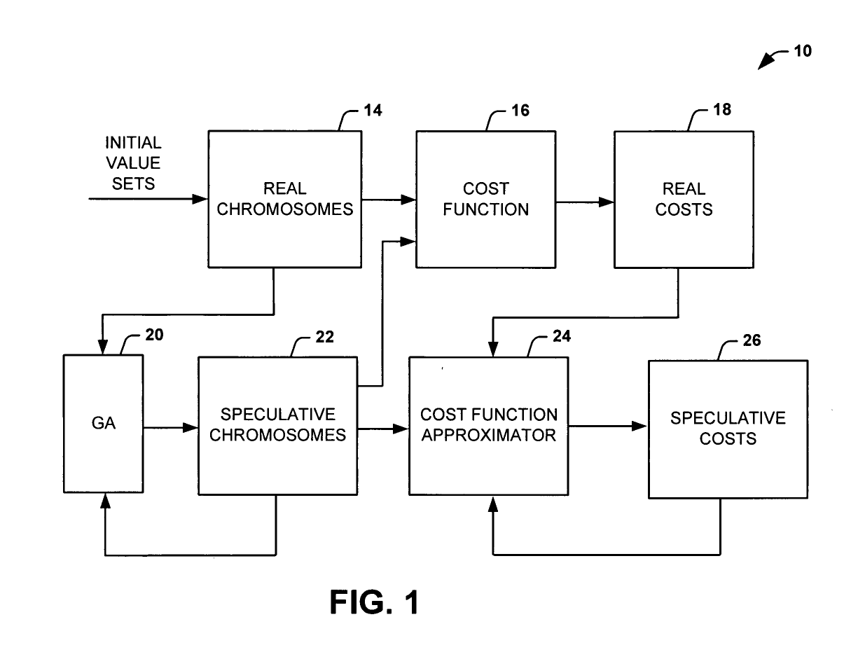

FIG. 1 illustrates a system 10 for selecting a value set associated with a set of parameters. The system 10 can be a computer, a server or some other computer readable medium that can execute computer readable instructions. For example, the components of the system 10 can be computer executable components, such as can be stored in a desired storage medium (e.g., random access memory, a hard disk drive, CD ROM, and the like), computer executable components running on a computer or design tool. The set of parameters can define properties or attributes associated with an optimizable function or structure. An optimizable function or structure refers to a solution that can be improved with adjustment of one or more parameters to achieve a desirable acceptable solution. The optimizable function or structure can be, for example, a circuit design, a mathematical problem or some other optimizable function or structure. Each value set associated with the set of parameters represents a potential solution to the optimizable function or structure. The system 10 selects a value set based on a desired fitness value or desired minimal cost. A change in value in any one of the parameters defines a new value set. Each value set is represented by a chromosome, with each parameter representing a gene in the chromosome.

The terms “real” and “speculative” are used herein to distinguish the terms modified thereby. For example, a real cost function is a basis cost function that generates a cost (e.g., real cost) associated with a value set. A speculative cost function provides a cost (e.g., speculative cost) that is an approximate of the cost (e.g., real cost) that would be generated by the basis cost function. A speculative cost function can be arbitrary or predetermined cost function that can be generated based on a real cost function value. The employment of a speculative cost function facilitates convergence of a desired solution by trading speed for accuracy.

The system 10 includes a set of real chromosomes 14 based on one or more initial value sets. A real chromosome is a value set employed by a real cost function 16 (e.g., multi-variable cost function) to generate real costs 18 associated with respective value sets. The set of real chromosomes 14 are provided to the real cost function 16 to generate real costs 18 associated with each of the real chromosomes 14.

Parent chromosomes are selected from the real chromosomes 14 to be used by a genetic algorithm 20 to generate children chromosomes. The children chromosomes are generated through a process of crossover and mutation of parent chromosomes to produce new children chromosomes. The children chromosomes generated by the genetic algorithm 20 are referred to as speculative chromosomes 22. The children chromosomes derived from parents of the real chromosomes are a first generation of speculative chromosomes. A speculative chromosome represents a value set employed by a cost function approximator 24 to generate speculative costs 26 associated with a value set variation of selected parent chromosomes. This enables an increase in speed of the selection system 10 since computing speculative costs 26, based on an approximation of the real costs 18, is faster than computing the real costs 18 employing the real cost function 16.

The genetic algorithm 20 can generate one or more generations of speculative chromosomes based on selecting parent chromosomes from the speculative chromosomes 22 and/or the real chromosomes 14. Speculative costs 26 can be approximated for speculative chromosomes 22 in subsequent generations, via the cost function approximator 24, similar to the approximation performed for first generation speculative chromosomes.

For example, the cost function approximator 24 employs two parents selected from the real chromosomes 14, a first generation speculative child chromosome generated from the selected real chromosome parents, and the cost-evaluation of the real parents to approximate a speculative cost for a given first generation speculative child chromosome. The cost function approximator 24 approximates the cost effects of an incremental change in a value set between a parent chromosome and a child chromosome, and subtracts the cost effects from the cost determined for the parent chromosome to provide an approximate cost for the child chromosome. The speculative costs can be approximated for one or more first generation speculative children chromosomes in a similar manner.

The genetic algorithm 20 generates a second generation of speculative children from the first generation speculative children, which become speculative parents of the second generation. Alternatively, parents can be selected from the speculative chromosomes 22 and the real chromosomes 14, such that one parent is selected from the speculative chromosomes 22 and another parent is selected from the real chromosomes 14 for a given child chromosome. The cost function approximator 24 employs the second generation parents, the second generation speculative child chromosome, and the cost-evaluation of the second generation parents to predict a speculative cost for the second generation speculative child chromosome. This is repeated for each speculative children chromosomes of the second generation. The genetic algorithm 20 generates third generation speculative chromosomes from parents selected from the second generation speculative chromosomes and/or real chromosomes 14, and determines speculative costs associated with the third generation speculative chromosomes. This process can be repeated for subsequent generations, until it is decided that validation of the speculative chromosomes 22 is desired.

Validation of the speculative chromosomes 22 is accomplished by executing the real cost function 16 on the speculative chromosomes 22 to generate real costs associated with the speculative chromosomes 22. The speculative chromosomes 22 then become real chromosomes 14 with associated real costs 18. Validation of the speculative chromosomes 22 may be initiated in many ways, examples of which may be based on the number of speculative generations, speculative costs converging or when a predetermined error level has been exceeded. It is to be appreciated that the inherent error of the cost function approximator 24 may increase with each generation of speculative chromosomes, since approximate cost might be based on previous approximations.

The set of real chromosomes 14 and associated real costs 18 can be evaluated to determine if an acceptable solution has been achieved. The acceptable solution can be determined in many ways, examples of which may include the number of generations, real costs 18 converging, or if or when a desired cost is achieved. If the acceptable solution has not been achieved, a new cost function approximator 24 can be generated based on a new set of real chromosomes 14 and real costs 18. The process of generating new generations of speculative chromosomes 22 and speculative costs 26 based on the new cost approximator 24 can be repeated. The new generations of speculative chromosomes 22, upon validation, can be employed to update the real chromosomes 14. This process repeats until an acceptable or desirable solution or value set has been achieved.

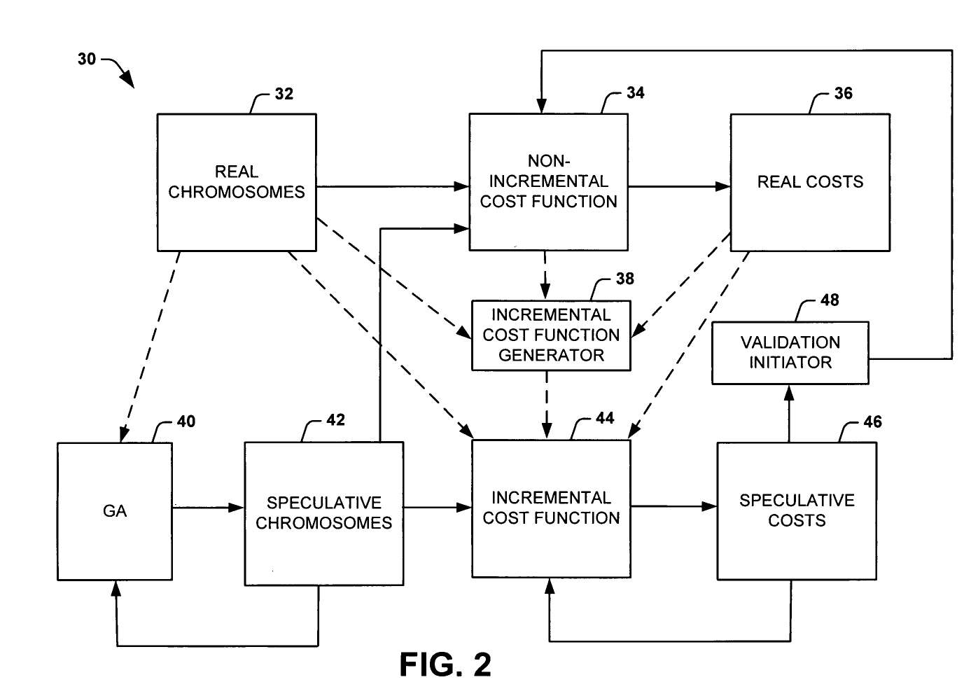

FIG. 2 illustrates an alternate system 30 for selecting a value set associated with a set of parameters. The system 30 can be a computer, a server or some other computer readable medium that can execute computer readable instructions. Each value set is represented as a chromosome, which may be a real chromosome or a speculative chromosome. A real chromosome is employed by a non-incremental or real cost function 34 to generate real costs 36 associated with one or more real chromosomes 32. A speculative chromosome is employed by an incremental cost function 44 to generate speculative costs 46 associated with one or more speculative chromosomes 42. A speculative cost is an approximate cost that is based on an incremental change in a chromosome (e.g., incremental change in value of one or more parameters) and an approximation of a cost difference between the cost associated with parent chromosome (e.g., mother chromosome, father chromosome), and a child chromosome.

The non-incremental or real cost function 34 determines a set of real costs 36 associated with the set of real chromosomes 32. An incremental cost function generator 38 generates an incremental cost function 44 based on the set of real chromosomes 32, and a minimum real cost assigned to the set of real chromosomes 32 based on the minimum real cost chromosome of the set 32. The real chromosomes 32 are provided to a genetic algorithm 40. The genetic algorithm 40 generates speculative children chromosomes 42 through a process of crossover and mutation of parent chromosomes selected from the real chromosomes 32. The children chromosomes derived from parents of the real chromosomes are a first generation of speculative chromosomes.

The speculative chromosomes 42 are provided to the incremental cost function 44. The incremental cost function 44 determines an incremental difference between the value sets of the parents selected from the real chromosomes 32 and the value sets of the first generation of speculative chromosomes 42. The incremental difference and the real costs associated with the parents selected from the real chromosomes 32 are employed to provide a speculative cost or approximate cost 46 associated with the speculative chromosome child. The speculative costs can be approximated for one or more first generation speculative children chromosomes in a similar manner.

The genetic algorithm 40 generates a second generation of speculative chromosome children from the first generation speculative children and/or real chromosomes 32, which become parents of the second generation. Alternatively, multiple combinations of speculative and/or real parents can be selected to generate various second generation children chromosomes. The genetic algorithm 40 generates speculative children chromosomes through a process of crossover and mutation of parent chromosomes.

The second generation speculative chromosomes are provided to the incremental cost function 44. The incremental cost function 44 employs the incremental difference between the value sets of the second generation parents and the value sets of the second generation speculative chromosome children. The incremental difference and the speculative costs 46 associated with the second generation parents are employed to provide speculative costs 46 associated with second generation speculative chromosome children. The process of selecting parent chromosomes, generating speculative children chromosomes and determining speculative costs with the new parent chromosomes can be repeated for N generations, where N is a positive integer.

A validation component 48 monitors the speculative costs 46 associated with the speculative chromosome 42 to determine when to initiate a validation. A validation comprises executing the non-incremental or real cost function 34 on one or more speculative chromosomes 42 to generate real costs 36 associated with the one or more speculative chromosomes 42. The new generation of speculative chromosomes 42, upon validation, can be employed to update the set of real chromosomes 32. Validation of the speculative chromosomes 42 may be initiated in many ways, examples of which may be based on the number of speculative generations, speculative costs converging or when a predetermined error level has been exceeded. It is to be appreciated that the inherent error of the incremental cost function 44 may increase with each generation of speculative chromosomes, since approximate cost might be based on previous approximations. It is appreciated that a variety of different criteria can be employed to determine when to initiate a validation.

The new set of real chromosomes 32 and real costs 36 are analyzed to determine if an acceptable or desirable solution exists. If an acceptable solution has not been achieved, the incremental cost function generator 38 is invoked and a new incremental cost function 44 is generated based on a new selected set of real chromosomes 32. Additional generations of speculative chromosomes 42 and speculative costs 46 are generated based on the new incremental cost function 44, until a validation is initiated. The process of validating, generating new incremental cost functions, new speculative generations and associated speculative costs are repeated until an acceptable or desirable solution has been achieved.

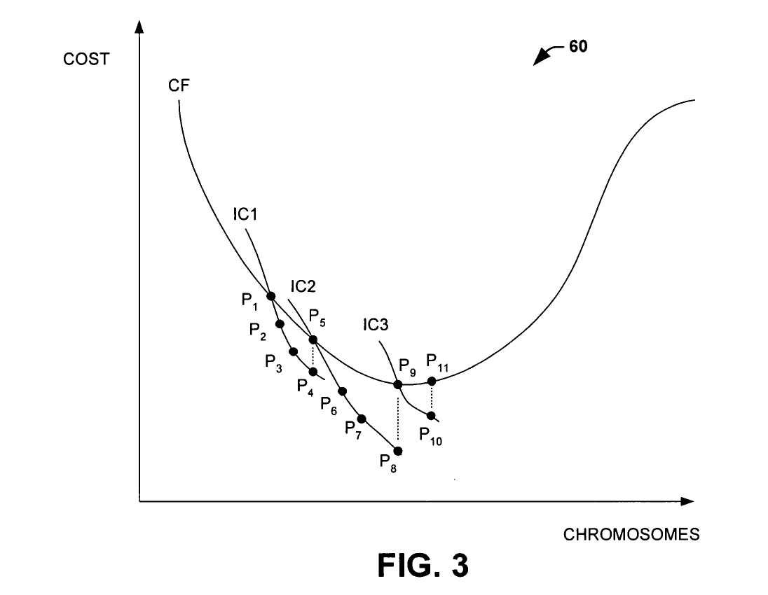

FIG. 3 is a graph 60 that illustrates a relationship between an exemplary real cost function (CF) and a plurality of incremental cost functions (IC1-IC3). The graph 60 illustrates the real cost function CF and the plurality of incremental cost functions (IC1-IC3) in two dimensions. However, it is to be appreciated that a multi-variable cost function will have as many dimensions as variables or parameters in the cost function. For example, a k variable cost function has k dimensions, where k is an integer greater than one. The number of variables and associated dimensions map to a single cost value. The graph 60 illustrates costs versus chromosome sets.

As illustrated in the graph 60, a first point P1, corresponding to a set of real chromosomes and associated minimum cost, resides on the cost function CF. From the point P1, a first incremental cost function (IC1) is generated. The set of real chromosomes is employed to generate a set of speculative chromosomes and associated speculative costs, represented as point P2 on IC1. The set of speculative chromosomes and associated speculative costs as represented as point P2 are employed to generate a new generation of speculative chromosomes and associated speculative costs, represented as point P3, via the first incremental cost function IC1. Alternatively, parents can be selected from the real chromosomes P1 and the speculative chromosomes P2. The set of speculative chromosomes and associated speculative costs represented as point P3 are employed to generate a new generation of speculative chromosomes and associated speculative costs, represented as point P4, via the first incremental cost function. Alternatively, parents can be selected from the real chromosomes P1 and the speculative chromosomes P2 and P3. At P4, a validation is initiated where one or more speculative chromosomes of the speculative chromosome set represented as P4 are provided to the real cost function (CF). A new set of real chromosomes and real costs are generated represented at point P5, as chromosomes at P4 are validated and moved to the cost function (CF).

The set of real chromosomes represented as P5 are employed to generate a second incremental cost function (IC2). The set of real chromosomes P5 and associated costs are employed to generate a set of speculative chromosomes and associated speculative costs, represented as point P6. The set of speculative chromosomes and associated speculative costs represented at point P6 are employed to generate a new generation of speculative chromosomes and associated speculative costs, represented as point P7, via the second incremental cost function (IC2). Alternatively, parents can be selected from the real chromosomes P5 and the speculative chromosomes P6. A subsequent generation of speculative chromosomes, represented as point P8, is generated employing the speculative chromosomes of P7 and associated speculative costs, via the second incremental cost function (IC2). Alternatively, parents can be selected from the real chromosomes P5 and the speculative chromosomes P6 and P7. At P8, a validation is initiated where one or more speculative chromosomes of the speculative chromosome set represented as P8 are provided to the cost function (CF). A new set of real chromosomes and real costs are generated represented as point P9.

The set of real chromosomes represented as point P9 are employed to generate a third incremental cost function (IC3). The set of real chromosomes P9 and associated costs are employed to generate a set of speculative chromosomes and associated speculative costs as represented as point P10. At P10, a validation is initiated where one or more speculative chromosomes of the speculative chromosome set represented as P10 are provided to the cost function (CF). A new set of real chromosomes and real costs are generated represented as point P111. It is determined that the new set or real chromosomes at point P11 have a higher cost than the chromosomes at P9. Therefore, P9 offers a better solution than P11. A minimal cost real chromosome is selected from the real chromosomes represented at P9 as a desirable solution. The selection routine then terminates. It is to be appreciated that more or less than three incremental cost functions can be generated to determine a desirable solution associated with the real cost function (CF).

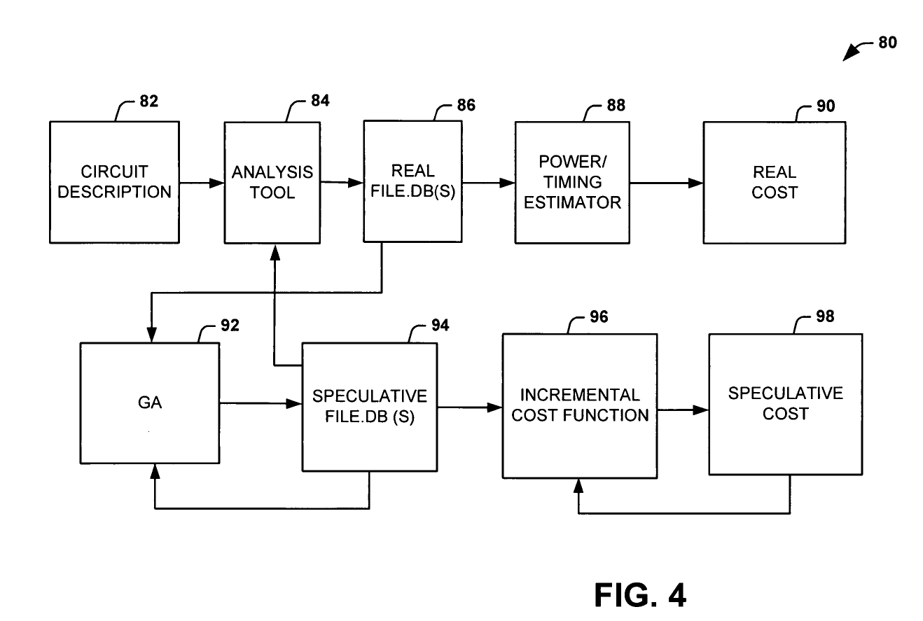

FIG. 4 illustrates a system 80 for selecting a circuit design configuration. The system 80 employs a circuit design description 82 to provide information to an analysis tool 84. The design description 82 can include transistor netlists, design netlists, design parasitic data and timing constraints associated with the circuit design. The analysis tool 84 executes a device modification and timing algorithm to optimize a circuit design. For example, the analysis tool 84 can be a static timing analysis tool (e.g., PATHMILL® by Synopsys) for block and chip timing verification. A static timing analysis tool will generate a plurality of circuit design configurations that correspond to device changes (e.g., transistor sizing, cell device modifications) based on timing and delay analysis to optimize the circuit design based on speed, power and area.

Alternatively, the analysis tool 84 can be a transistor autosizer (e.g., AMPS® by Synopsys). Most transistor autosizers rely on heuristic approaches that focus on finding the best combination that will meet user-defined power and speed goals without changing the functionality of the design. The transistor autosizers employ an original circuit design description to generate a plurality of circuit sizing configurations that define different optimized cell netlist configurations.

The analysis tool 84 performs timing analysis, transistor sizing optimization, device modifications and/or power analysis on the circuit design description 82. The analysis tool 84 executes timing analysis and modifies transistor sizes and/or circuit cell configurations to optimize the circuit design without disturbing the functionality associated with the circuit design. The analysis tool 84 then generates one or more real file data bases (File.DB(s)). Each of the one or more real file data bases 86 defines a circuit configuration, and a potential circuit design solution. Each circuit configuration or real file data base 86 is represented as a real chromosome. Any change in the circuit design parameter values (e.g., device width, device length, circuit types, cell types) defines a new real chromosome associated with the circuit design. The information associated with the one or more real file data bases 86 is provided to a power/timing estimator 88 that generates a real cost 90, as a function of power and timing characteristics, associated with each real chromosome. The analysis tool 84 and the power/timing estimator 88 cooperate to define a real cost function associated with optimization of the circuit design.

The real file data bases 86 or real chromosomes are provided to a genetic algorithm 92. The genetic algorithm 92 generates speculative chromosomes in the form of speculative file data bases 94 (File.DB(s)) through a process of crossover and mutation of parent chromosomes selected from the real file data bases 86. The speculative file data bases 94 are provided to an incremental cost function 96, which determines speculative costs associated with a respective speculative file database 94.

The incremental cost function 96 employs the incremental difference between parent chromosomes having real file data bases 86 and speculative child chromosomes having speculative file data bases 94. The incremental difference and the real cost associated with the real parent file data bases 86 is employed to provide a speculative cost associated with each speculative child chromosome or speculative file data base 94. For example, a change in a circuit design parameter value, such as gate width can be made to generate a speculative file data base from one or more real file databases. An estimated change in power can be determined based on the gate width change. The estimated change in power and the power computed by the power timing/estimator 88 for the real file data base 86 can be employed to determine an approximate power associated with the speculative file data base 94.

Parent chromosomes are then selected from the speculative file data bases 94, such that speculative chromosomes become parents of a second generation of speculative chromosomes. Alternatively, parents can be selected from the speculative file data bases 94 and the real file data bases 86, such that one parent is real and another parent speculative for a given child chromosome. The speculative file data bases 94 and/or the real file data bases 86 are employed by the genetic algorithm 92 to produce a subsequent generation of speculative file data bases. Alternatively, multiple combinations of speculative and/or real parents can be selected to generate various second generation children chromosomes. The second generation speculative file data bases are provided to the incremental cost function 96. The incremental cost function 96 employs the incremental difference of circuit design configuration associated with the parent file data bases and the second generation speculative file data bases. The incremental difference and the speculative cost associated with the parent chromosomes are employed to provide a speculative cost associated with each second generation speculative child chromosomes. This process can then be repeated for subsequent generations (e.g., 3^{rd} generation, 4^{th} generation, etc.) of speculative file data bases employing parents of a previous speculative generation and/or real parents.

Validation of the speculative file data bases 84 can be initiated when a predetermined number of generations has been generated, when speculative costs 98 associated with new generations converges, or when a predetermined error level has been achieved. It is appreciated that a variety of different criteria can be employed to determine when to initiate a validation. During validation, the speculative file data bases 94 associated with the speculative circuit design configurations are provided to the analysis tool 84. The analysis tool 84 then executes the parameter values associated with the speculative file data bases 94 to generate real file data bases 86 associated with the circuit design configurations. The power/timing estimator 88 then generates real costs associated with the new real file data bases 84.

The new set of real file data bases 86 and real costs 90 are analyzed to determine if a desirable solution exists. If an desirable solution has not been achieved, the new set of real file data bases 86 are employed as parent chromosomes to generate additional generations of speculative chromosomes and speculative costs via a new incremental cost function. The process of validating, generating new incremental cost functions, new speculative generations and associated speculative costs are repeated until a desirable circuit design has been achieved.

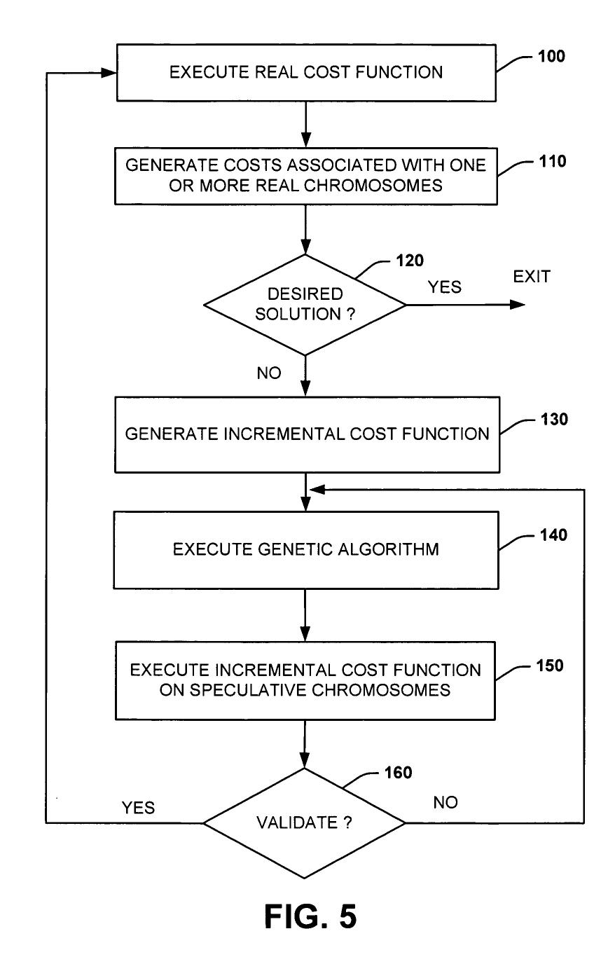

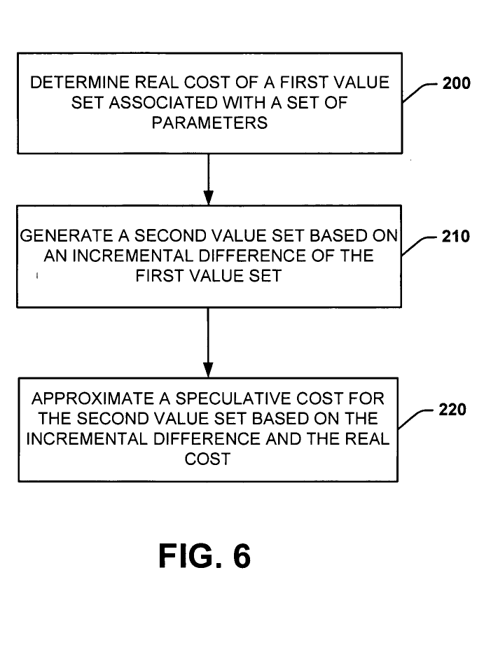

In view of the foregoing structural and functional features described above, certain methodologies that can be implemented will be better appreciated with reference to FIGS. 5-6. While, for purposes of simplicity of explanation, the methodologies of FIGS. 5-6 are shown and described as being implemented serially, it is to be understood and appreciated that the illustrated actions, in other embodiments, may occur in different orders and/or concurrently with other actions. Moreover, not all illustrated features may be required to implement a methodology. It is to be further understood that the following methodologies can be implemented in hardware, software (e.g., computer executable instructions), or any combination thereof.

It is to be further understood that the following methodology can be implemented in hardware, software, or any combination thereof. For example, in one embodiment the methodologies can be implemented as computer executable instructions, such as can be stored in a desired storage medium (e.g., random access memory, a hard disk drive, CD ROM, and the like). In another embodiment, a methodology can be implemented as computer executable instructions running on a computer or design tool.

FIG. 5 illustrates a methodology for selecting a value set associated with a set of parameters. At 100, a real cost function is executed on one or more value sets associated with a set of parameters. Each value set is represented as a real chromosome with each parameter value being represented by a gene associated with the real chromosome. For example, the set of parameters can be parameters (e.g., device width, device length, circuit types, cell types) associated with a circuit design. At 110, real costs are generated for each of the one or more real chromosomes that represent one or more value sets associated with a set of parameters. At 120, it is determined if a desired solution has been obtained by analyzing the real costs associated with the one or more real chromosomes. If the desired solution has been achieved (YES), the methodology terminates or exits. If the desired solution has not been achieved (NO), the methodology proceeds to 130.

At 130, an incremental cost function is generated based on the selected real chromosomes and associated real costs (e.g., minimum real cost of the set of real chromosomes). The incremental cost function can be arbitrary, based on the real cost function or be formulated based on approximation results. At 140, a genetic algorithm is executed to generate at least one speculative chromosome. A speculative chromosome is an incremental modification of a value set associated with one or more parent chromosomes. The parent chromosomes can be real or speculative. This is repeated for at least two iterations. In a first iteration, the one or more speculative chromosomes are generated based on parents associated with real chromosomes. In subsequent iterations, the one or more speculative chromosomes are generated based on speculative chromosome parents from previous generations or combinations of real and speculative chromosome parents from previous generations.

At 150, the incremental cost function is executed. The incremental cost function employs the incremental difference between the value sets of the parent chromosomes and the value sets of child chromosomes. The incremental difference can be a change in one or more parameters associated with the parameter set. The incremental difference and the cost associated with the parent chromosomes are employed to provide a speculative cost associated with speculative child chromosomes. In the first iteration, real costs associated with real chromosome parents are employed to determine a speculative cost. In subsequent iterations, speculative costs associated with speculative parent chromosomes and/or real costs associated with real chromosomes are employed to determine a speculative cost for subsequent generations. The incremental cost function employs costs of parent chromosomes and incremental differences in the value set to approximate a speculative cost. The methodology then proceeds to 160.

At 160, the methodology determines whether to validate the speculative chromosomes or to generate additional generations. If the methodology determines a validation is desired (YES), the methodology returns to 100. A validation comprises executing the real cost function on one or more speculative chromosomes to generate real costs associated with the one or more speculative chromosomes, thus adding the one or more speculative chromosomes to the set of real chromosomes. Validation of the speculative chromosomes may be initiated in many ways, examples of which may be based on the number of speculative generations, speculative costs converging or when a predetermined error level has been exceeded. It is appreciated that a variety of different criteria can be employed to determine when to initiate a validation. If the methodology determines a validation is not desired (NO), the methodology returns to 140 to generate a new generation of speculative chromosomes and speculative costs.

FIG. 6 illustrates an alternate methodology for selecting a value set associated with a set of parameters. At 200, a real cost of a first value set associated with a set of parameters is determined. The methodology then proceeds to 210. At 210, a second value set is generated based on a difference of the first value set. The methodology then advances to 220. At 220, a speculative cost is approximated for the second value set based on the difference and the real cost. One or more additional values sets based on differences from the first and/or second value set can be generated, and a speculative cost approximated for the one or more additional value sets.

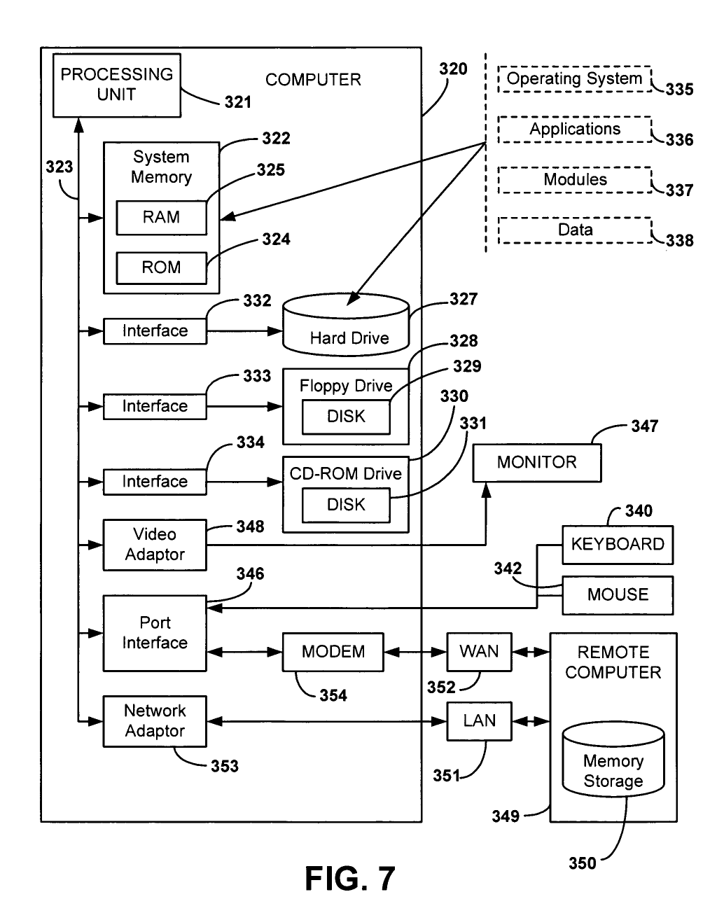

FIG. 7 illustrates a computer system 320 that can be employed to execute one or more embodiments employing computer executable instructions. The computer system 320 can be implemented on one or more general purpose networked computer systems, embedded computer systems, routers, switches, server devices, client devices, various intermediate devices/nodes and/or stand alone computer systems. Additionally, the computer system 320 can be implemented on various mobile clients such as, for example, a cell phone, personal digital assistant (PDA), laptop computer, pager, and the like.

The computer system 320 includes a processing unit 321, a system memory 322, and a system bus 323 that couples various system components including the system memory to the processing unit 321. Dual microprocessors and other multi-processor architectures also can be used as the processing unit 321. The system bus may be any of several types of bus structure including a memory bus or memory controller, a peripheral bus, and a local bus using any of a variety of bus architectures. The system memory includes read only memory (ROM) 324 and random access memory (RAM) 325. A basic input/output system (BIOS) can reside in memory containing the basic routines that help to transfer information between elements within the computer system 320.

The computer system 320 can includes a hard disk drive 327, a magnetic disk drive 328, e.g., to read from or write to a removable disk 329, and an optical disk drive 330, e.g., for reading a CD-ROM disk 331 or to read from or write to other optical media. The hard disk drive 327, magnetic disk drive 328, and optical disk drive 330 are connected to the system bus 323 by a hard disk drive interface 332, a magnetic disk drive interface 333, and an optical drive interface 334, respectively. The drives and their associated computer-readable media provide nonvolatile storage of data, data structures, and computer-executable instructions for the computer system 320. Although the description of computer-readable media above refers to a hard disk, a removable magnetic disk and a CD, other types of media which are readable by a computer, such as magnetic cassettes, flash memory cards, digital video disks and the like, may also be used in the operating environment, and further that any such media may contain computer-executable instructions.

A number of program modules may be stored in the drives and RAM 325, including an operating system 335, one or more application programs 336, other program modules 337, and program data 338. A user may enter commands and information into the computer system 320 through a keyboard 340 and a pointing device, such as a mouse 342. Other input devices (not shown) may include a microphone, a joystick, a game pad, a scanner, or the like. These and other input devices are often connected to the processing unit 321 through a corresponding port interface 346 that is coupled to the system bus, but may be connected by other interfaces, such as a parallel port, a serial port or a universal serial bus (USB). A monitor 347 or other type of display device is also connected to the system bus 323 via an interface, such as a video adapter 348.

The computer system 320 may operate in a networked environment using logical connections to one or more remote computers, such as a remote client computer 349. The remote computer 349 may be a workstation, a computer system, a router, a peer device or other common network node, and typically includes many or all of the elements described relative to the computer system 320. The logical connections can include a local area network (LAN) 351 and a wide area network (WAN) 352.

When used in a LAN networking environment, the computer system 320 can be connected to the local network 351 through a network interface or adapter 353. When used in a WAN networking environment, the computer system 320 can include a modem 354, or can be connected to a communications server on the LAN. The modem 354, which may be internal or external, is connected to the system bus 323 via the port interface 346. In a networked environment, program modules depicted relative to the computer system 320, or portions thereof, may be stored in the remote memory storage device 350.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims.

1. A value set selection system, comprising:
a real cost function that generates a real cost for a first value set associated with a set of parameters;
a genetic algorithm that generates a second value set that is a value set variation of the first value set; and
a cost function approximator that determines an approximate cost based on the real cost and the value set variation between the second value set and the first value set.

2. The system of claim 1, the genetic algorithm generates at least one additional value set that is a variation of the second value set.

3. The system of claim 2, the cost function approximator determines an approximate cost for the at least one additional value set based on the approximate cost of the second value set and the at least one additional value set.

4. The system of claim 1, the cost function approximator comprising an incremental cost function that determines the approximate cost of the first value set variation based on an incremental difference between at least one parameter of the first value set and the second value set, and the real cost associated with the first value set.

5. The system of claim 4, the genetic algorithm generates subsequent generations of value sets based on value set variations derived from at least one of the first value set and the second value set, the incremental cost function determines an approximate cost of a value set variation based on an incremental difference between the value set variation of a subsequent generation and the value set variation of a preceding generation, and a cost associated with the value set variation of the preceding generation.

6. The system of claim 4, further comprising an incremental cost function generator that generates the incremental cost function based on the first value set and an associated real cost for the first value set.

7. The system of claim 1, further comprising a first group of value sets represented as real chromosomes, the real cost function provides corresponding real costs associated with each of the real chromosomes, and a second group of value sets represented as speculative chromosomes, the cost function approximator provides corresponding approximate costs associated with the speculative chromosomes.

8. The system of claim 7, the genetic algorithm generates the second group of value sets represented as speculative chromosomes from parents selected from the real chromosomes.

9. The system of claim 8, the genetic algorithm generates at least one additional generation of speculative chromosomes originating from parents selected from at least one of the speculative chromosomes and real chromsomes, the at least one additional generation being added to the second group of value sets.

10. The system of claim 8, the genetic algorithm selects parents from the second group of value sets based on the corresponding approximate costs associated with speculative chromosomes.

11. The system of claim 7, further comprising a validation component that initiates a validation of at least one value set represented as at least one speculative chromosome, the validation comprising executing the real cost function to provide a real cost associated with the at least one speculative chromosome and adding the at least one speculative chromosome to the first group of value sets.

12. The system of claim 11, the validation being initiated based on one of speculative generation, approximate costs converging and errors exceeding a predetermined level.

13. The system of claim 1, the real cost function comprising an optimization tool for optimizing a circuit design, and the given value set being a circuit configuration generated by the optimization tool.

14. A system for selecting a value set associated with a set of parameters, the system comprising:
a real cost function that determines a real cost for each of a plurality of real chromosomes that represent different value sets associated with a set of parameters;
a genetic algorithm that generates a first generation of speculative children chromosomes from parents selected from the plurality of real chromosomes, the genetic algorithm generates subsequent generations of speculative children chromosomes from parents selected from at least one of preceding generations of speculative chromosomes and the plurality of real chromosomes, the speculative chromosomes representing incremental differences in the value sets between at least one parent chromosome and an associated child chromosome; and
an incremental cost function that determines speculative costs for a given speculative chromosome based on the incremental difference in the value sets between at least one parent chromosome and an associated child chromosome and the cost associated with at least one of the parent chromosomes.

15. The system of claim 14, further comprising an incremental cost function generator that generates the incremental cost function based on a minimum real cost associated with the plurality of real chromosomes.

16. The system of claim 15, further comprising a validation component that initiates a validation of at least one speculative chromosome, the validation comprising executing the real cost function on the at least one speculative chromosome to associate a real cost with the at least one speculative chromosome and adding the at least one speculative chromosome to the plurality of real chromosomes.

17. The system of claim 16, the incremental cost function generator generates at least one additional incremental cost function in response to a validation being initiated if a desirable solution associated with the set of parameters has not been achieved.

18. The system of claim 14, the real cost function comprising an optimization tool for optimizing a circuit design, and the plurality of real chromosomes being a plurality of data base files representing different circuit configurations generated by the optimization tool.

19. A system for determining costs associated with a set of parameter values representing a solution, the system comprising:
means for generating real chromosomes representing different value sets associated with a set of parameters;
means for determining a real cost of at least one of the generated real chromosomes;
means for generating a speculative chromosome representing value set variations from at least one of the generated real chromosomes; and
means for determining a speculative cost based on the real cost and a difference in value sets of at least one of the generated real chromosomes and the speculative chromosome.

20. The system of claim 19, the means for generating a speculative chromosome being operative to generate additional generations of speculative chromosomes and the means for determining a speculative cost being based on a difference in value sets of parent chromosomes and speculative child chromosomes and a cost associated with at least one parent chromosome.

21. The system of claim 19, further comprising means for initiating validation of at least one speculative chromosome by executing the means for determining a real cost on the value set of the at least one speculative chromosome.

22. The system of claim 19, further comprising means for generating the means for determining a speculative cost based on an initial real chromosome and an associated real cost.

23. The system of claim 18, the means for generating the means for determining a speculative cost being repeated upon validation of at least one speculative chromosome if a desired cost associated with the set of parameters has not been achieved.

24. A method for selecting a value set associated with a set of parameters, comprising:
determining a real cost of a first value set associated with a set of parameters;
generating a second value set based on a difference in at least one value of the first value set; and
approximating a speculative cost for the second value set based on the difference and the real cost.

25. The method of claim 24, further comprising generating a third value set based on an incremental difference in at least one value of the second value set and approximating a speculative cost for the third value set based on the incremental difference in at least one value of the second value set, and the speculative cost associated with the second value set.

26. The method of claim 25, the first value set is represented as real chromosome and the second and third value sets are represented as speculative chromosomes, the second and third value set being generated by a genetic algorithm.

27. The method of claim 26, further comprising executing the genetic algorithm to generate a plurality of speculative chromosome generations from the second value set, and approximating a speculative cost for the speculative chromosomes based on incremental differences in at least one value between parents and child speculative chromosomes and costs of at least one of the parent chromosomes.

28. The method of claim 27, further comprising validating at least one speculative chromosome by determining a real cost associated with the at least one speculative chromosome, and replacing at least one real chromosome associated with the first value set with the at least one speculative chromosome if the at least one speculative chromosome has a lower real cost than the at least one real chromosome.

29. A computer-readable medium having computer-executable instructions for performing the method of claim 24.
